(19) United States
(12) Patent Application Publication
(10) Pub. No.: US 2004/0233174 A1
(43) Pub. Date: Nov. 25, 2004

(54) Vibration sensing touch input device

(76) Inventors: Michael J. Robrecht, Shorewood, WI (US); Nicholas Patrick Roland Hill, Cambridge (GB); Darius Martin Sullivan, Cambridge (GB)

Correspondence Address: 3M INNOVATIVE PROPERTIES COMPANY, PO BOX 33427, ST. PAUL, MN, 55133-3427, US

(21) Appl. No.: 10/440,650

(22) Filed: May 19, 2003

(51) Int. Cl. G09G 5/00

(52) U.S. Cl. 345/173

(57) ABSTRACT

Disclosed is a touch input device that determines touch position by sensing vibrations propagating in a touch plate that are indicative of a touch to the touch plate. Vibration sensing devices such as piezoelectric sensors are used to sense the vibrations. Selecting the size, shape, placement position and orientation of the sensors on the touch plate can enhance sensitivity of the sensors to vibration and yield symmetric response with respect to the direction of vibration propagation. Also disclosed is a method of making a vibration sensing touch input device.

This invention relates to touch input devices. In particular, the invention relates to touch input devices that use information from vibrations in the touch panel to determine the location of a touch.

### BACKGROUND

Electronic displays are widely used in all aspects of life. Although in the past the use of electronic displays has been primarily limited to computing applications such as desktop computers and notebook computers, as processing power has become more readily available, such capability has been integrated into a wide variety of applications. For example, it is now common to see electronic displays in a wide variety of applications such as teller machines, gaming machines, automotive navigation systems, restaurant management systems, grocery store checkout lines, gas pumps, information kiosks, and hand-held data organizers to name a few.

### SUMMARY OF THE INVENTION

The present invention provides a touch input device that includes a rectangular substrate and at least three elongated piezoelectric sensors coupled to the substrate and configured to sense vibrations propagating in the substrate that are indicative of a touch on the touch input device, each sensor located near a corner of the substrate and oriented to provide symmetric sensitivity to the direction of vibration propagation. Controller electronics can be coupled to the sensors and configured to calculate touch location using information from the sensed vibrations indicative of the touch. Also, a display can be disposed for viewing through the touch input device.

In another embodiment the present invention provides a touch input panel including a rectangular substrate and at least three elongated piezoelectric sensors coupled to the substrate. The sensors are configured to sense vibrations propagating in the substrate that are indicative of a touch on the touch input device and are coupled to wires configured for communicating information from the sensed vibrations to a controller. The controller calculates a touch location using the information. Each of the sensors are located near a corner of the substrate and oriented to provide symmetric sensitivity to the direction of vibration propagation.

The present invention also provides a method for making vibration sensing touch input devices. The method includes providing a rectangular substrate capable of supporting vibrations propagating in the substrate that are indicative of a touch on the substrate; selecting sensor areas on the substrate near the substrate corners and a tail area on the substrate near an edge of the substrate; patterning pairs of wires on the substrate, each pair of wires extending along one or more edges of the substrate from one of the sensor areas to the tail area; providing piezoelectric sensors activatable by applying voltage across two electrodes, the electrodes configured to be accessible from the same side of the sensor; and affixing one of the sensors to each of the sensor areas so that each wire of each respective pair of wires electrically connects to a unique one of the electrodes of each respective sensor. A circuit tail can be connected to the wires on the substrate for communication with controller electronics.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a schematic side view of a touch input device system of the present invention;

FIG. 2(a) is a schematic plan view of a touch panel according to an embodiment of the present invention;

FIG. 2(b) is a schematic view of a touch panel according to an embodiment of the present invention;

FIG. 3 is a partial schematic plan view of a touch panel according to an embodiment of the present invention illustrating positioning of an elongated bending wave sensor;

FIG. 4 is a partial schematic plan view of a touch panel according to an embodiment of the present invention illustrating wire connected to a bending wave sensor;

FIG. 5 is a schematic plan view of a touch panel according to an embodiment of the present invention indicating wire and tail placement; and

FIG. 6 shows steps in an embodiment of a process of making a bending wave touch panel according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention relates to touch activated user input devices that sense vibrations indicative of a discrete touch that propagate through a touch plate for sensing by a number of piezoelectric devices. Information from the sensed vibrations can be used to determine the location of the touch. Vibration sensing touch input devices particularly suited to detecting and determining touch position from bending wave vibrations are disclosed in International Publications WO 2003 005292 and WO 0148684, the disclosures of which are wholly incorporated into this document.

The present invention further relates to the placement of piezoelectric sensor devices in vibration sensing touch input devices, and particularly to the positioning of the sensors, the orientation of the sensors, the shape of the sensors, and so forth, to achieve enhanced sensitivity. By selecting size, shape, position and orientation of the sensors, relative independence to vibration propagation direction can be obtained, as well as achieving a sensor response that is symmetric with respect to vibration propagation direction.

In vibration sensing touch input devices that include piezoelectric sensors, vibrations propagating in the plane of the touch panel plate stress the piezoelectric sensors, causing a detectable voltage drop across the sensor. The signal received can be caused by a vibration resulting directly from the impact of a touch input, or by a touch input influencing an existing vibration, for example by attenuation of the vibration.

Upon receiving a signal indicative of a touch, the differential times at which the same signal is received at each of the sensors can be used to deduce the location of the touch input. As disclosed in International Publications WO 2003 005292 and WO 0148684, when the propagation medium is a dispersive medium, the vibration wave packet, which is composed of multiple frequencies, becomes spread out and attenuated as it propagates, making interpretation of the signal difficult. Thus, it has been proposed to convert the received signals so they can be interpreted as if they were propagated in a non-dispersive medium. Such a technique is particularly suited to systems that detect bending wave vibrations.

Piezoelectric sensors are particularly suited for use in devices of the present invention due to their sensitivity, relative low cost, adequate robustness, potentially small form factor, adequate stability, and linearity of response. Other sensors that can be used in vibration sensing touch input devices include electrostrictive, magnetostrictive, piezoresistive, and moving coil, among others.

Piezoelectric elements generally take one of two forms for vibration sensing applications. The first is a unimorph element, which is sensitive to compression in each of its axes. The second is a bimorph element, which is composed of two unimorphs arranged to have opposite polarity and is sensitive to curvature. The choice of which sensor type to use is dependent on the material to which the sensor. When a plate undergoes bending from a bending wave, for example, the surface of the plate is placed into curvature and into compression. The ratio of curvature to compression depends on the thickness and stiffness of the plate. As the plate is made thicker and stiffer, then for a given frequency and amplitude of disturbance, the curvature decreases (due to a greater bending wavelength) and the surface compression increases (due to the surface being further from the neutral axis). Consequently, unimorph sensors can be more sensitive than bimorph sensors on thicker, stiffer panels, and vice versa.

Many applications that employ touch input devices also use electronic displays to display information through the touch device. Since displays are typically rectangular, it is typical and convenient to use rectangular touch devices. As such, the touch plate to which the sensors are affixed is typically rectangular in shape. In the present invention, the vibration sensors can be placed near the corners of the touch plate. Because many applications call for a display to be viewed through the touch input device, it is desirable to place the sensors out near the edges of the touch plate so that they do not undesirably encroach on the viewable display area. Placement of the sensors at the corners can also reduce the influence of reflections from the panel edges. For a vibration sensor arbitrarily positioned along an edge of the touch plate, the signal received due to the touch input event is the sum of the first arrival of the vibration wave packet plus later, delayed reflections of the vibration wave packet from the edges of the plate. The proximity of either the sensor or the touch input to an edge of the plate determines the separation of the direct signal to the first reflected signal. Locating the sensors at the corners increases the separation of the sensor from a possible reflecting boundary, which aids in the separation of the primary and reflected signals for better contact detection.

The shape of the vibration sensor can also be important. It is desirable the sensor exhibit an omnidirectional response, in other words that the sensor response is relatively insensitive to the direction of vibration propagation. A sensor having a strong angular dependence may undesirably complicate the correlation calculation of touch position from the received signals. To investigate the angular dependence of a piezoelectric sensor's response, the sensor can be driven so that it acts as an emitter. Then, using a laser vibrometer, the outgoing wave can be measured. Angular independence of the piezoelectric device as an emitter can be correlated to expected angular independence of the piezoelectric device as a sensor. Under such analyses, it can be determined that elongated piezoelectric transducers, such as those having elongated rectangular or elliptical shapes, provide better omnidirectionality than square or circular shaped transducers, particularly when affixed at the corner of a substrate. For example, a rectangular transducer, having an approximately 3:1 length to width aspect ratio that is bonded near the corner of a rectangular plate of soda lime glass and oriented with its long axis making a 45 degree angle with the edges of the plate, exhibits a highly symmetric emitted wave when driven. A similar measurement made using a quarter circle or a square mounted to fit to the corner of a panel does not yield an omnidirectional response.

Related to angular sensitivity is the degree of angular symmetry of the response provided by a sensor. The long axis of an elongated piezoelectric transducer is its axis of greatest sensitivity. By orienting the axis of greatest sensitivity of an elongated piezoelectric sensor to make 45 degree angles with the sides of a rectangular touch plate and positioning the sensor near a corner of the plate, symmetric sensitivity can be obtained. If such a sensor were to point along one of the plate edges, then vibrations propagating in the direction of that plate edge may be sensed with greater sensitivity than orthogonally propagating vibrations. By orienting the sensor with its axis of greatest sensitivity at about 45 degrees to the plate edges, a high degree of symmetry can be achieved, particularly when using an elongated sensor.

The sensor area (length and width), material, and thickness can also be selected to achieve higher sensitivity of the device while satisfying other constraints such as reducing the border area of the touch panel. The sensitivity of a piezoelectric device is determined from an energy argument. On the one hand there is strain energy that is introduced into the piezoelectric element, and on the other hand there is electrical energy that is stored when the capacitive load of the piezoelectric element is raised to a given voltage. Because the piezoelectric effect is efficient, the sensitivity of the device may be determined by setting these quantities equal. Enhancing the sensitivity may be particularly useful when using particularly thick and/or stiff panels, such as glass sheets, characteristic of those used in many touch sensing applications. For these types of touch plates, a contact of a finger or stylus generates relatively small bending wave displacements of the panel, and thus sensitive transducers are desirable.

Sensor size may be chosen with the following factors in mind. The length and width of the sensors may be selected so that the sensors do not undesirably encroach on the viewing area. Also of potential consideration is the length of an elongated sensor as compared to the expected range of bending wave wavelengths, if bending wave vibrations are to be sensed for determination of touch position. In the limit where the length of the sensor exceeds the bending wavelengths of interest, the sensitivity of the sensor begins to drop because the motion in the plate caused by those waves will tend to become averaged out over the length of the piezoelectric element. Exemplary piezoelectric sensors have a length that is generally less than the vibration wavelengths at the highest frequency band of interest. In bending wave applications of the present invention, rectangular piezoelectric sensors having lengths of about 7 mm and widths of about 3 mm may be used, as one example.

The height of the sensor may be selected so that the sensor does not excessively add to the thickness of the panel, which could complicate the integration of the touch device into a display system. Rectangular piezoelectric sensors having heights of about 1 mm may be used, for example.

In addition to selecting the size (length, width, height) of the bending wave sensors to enhance the strain energy in the material, and thus the sensitivity of the sensor, piezoelectric material formulation can be selected to enhance performance. The material formulation is one factor that determines the capacitance of the sensor, which in turn determines the voltage generated for a given charge. In exemplary embodiment, the sensor material composition can be selected to reduce the dielectric constant, thereby reducing the sensor capacitance and increasing the voltage sensitivity. An exception to this rule may exist under circumstances where reducing the dielectric constant amounts to a reduction in piezoelectric efficiency, in which case the expected gain in sensitivity could be lost. The choice of piezoelectric formulation is therefore preferably made by balancing these concerns. One suitable piezoelectric crystal material is lead-zirconate-titanat (PZT).

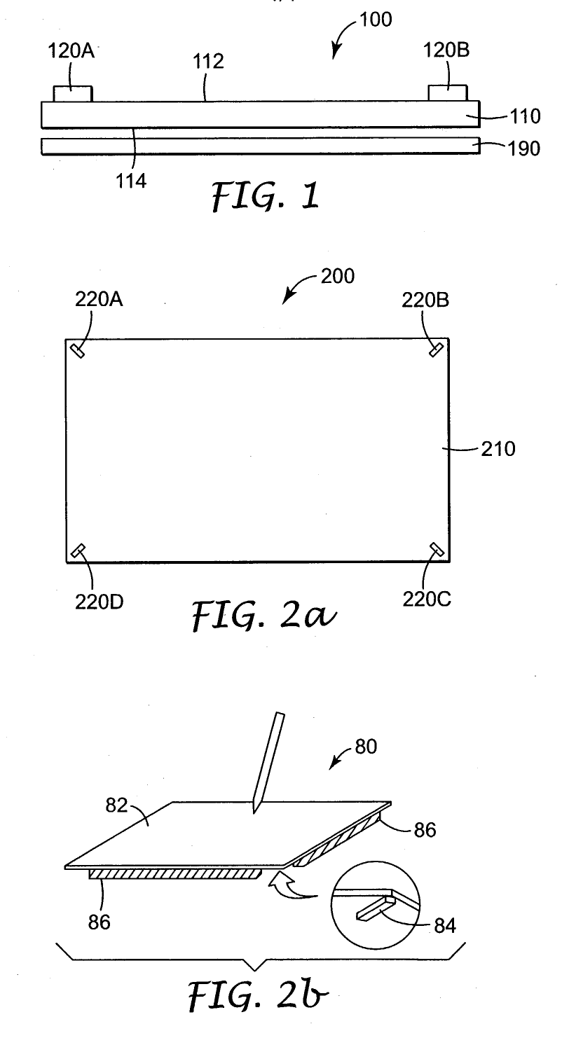

FIG. 1 shows a schematic side view of a touch panel 100 that includes a substrate 110 and vibration sensors 120A and 120B coupled to top surface 112 of the substrate 110. Top surface 112 can provide the touch surface. Although sensors 120A and 120B are shown coupled to the top surface 112, the sensors could alternatively be coupled to the bottom surface 114. In other alternative embodiments, one or more sensors could be coupled to top surface 112 while one or more other sensors could be coupled to bottom surface 114. Substrate 110 can be any substrate that supports vibrations of interest, such as bending wave vibrations. Exemplary substrates include plastics such as acrylics or polycarbonates, glass, or other suitable materials. Substrate 110 can be transparent or opaque, and can optionally include or incorporate other layers or support additional functionalities. For example, substrate 110 can provide scratch resistance, smudge resistance, glare reduction, anti-reflection properties, light control for directionality or privacy, filtering, polarization, optical compensation, frictional texturing, coloration, graphical images, or the like.

Touch panel 100 includes sensors 120A and 120B. Although only two sensor are depicted in the side view, generally at least three sensors are needed to determine the position of a touch input in two dimensions, and four sensors may be desirable in some embodiments, as discussed in International Publications WO 2003 005292 and WO 0148684. In the present invention, sensors 120A and 120B are piezoelectric sensors that can sense vibrations indicative of a touch input to substrate 110. Exemplary piezoelectric devices use PZT crystals. Optionally, one or more of the sensors can be used as an emitter device to emit a signal that can be sensed by the other sensors to be used as a reference signal or to create vibrations that can be altered under a touch input, such altered vibrations being sensed by the sensors to determine the position of the touch. Sensors 120A and 120B can be affixed or bonded to substrate 110 by any suitable means such as by use of an adhesive.

FIG. 1 also shows an optional display device 190 positioned to display information through the touch panel 100 toward a viewer position. Display device 190 can be any suitable electronic display such as a liquid crystal display, an electroluminescent display, a cathode ray tube display, a plasma display, a light emitting diode display, and the like. Display device 190 may additionally or alternatively include static graphics that can be permanent or replaceable.

FIG. 2(a) shows a schematic plan view of a touch panel 200 that includes a rectangular substrate 210 and rectangular elongated piezoelectric sensors 220A, 220B, 220C and 220D, each positioned near one of the corners of substrate 210. The sensors are shown to be oriented with their respective axes of greatest sensitivity lying along 45 degree angles with the adjacent edges of the substrate.

FIG. 2(b) shows a contact sensitive device 80 comprising a rectangular member 82 capable of supporting bending waves, for example, and four sensors 84 for measuring vibrations in the member. The sensors 84 are in the form of piezoelectric vibration sensors and are mounted on the underside of the member 82, one at each corner. A foam mounting 86 is attached to the underside of the member and extends substantially around the periphery of the member. The foam mounting 86 has adhesive surfaces whereby the member may be securely attached to any surface. The foam mounting may reduce the reflections from the edge of the member. As shown, piezoelectric vibration sensors 84 can be rectangular and can be mounted so that their long axes point toward adjacent corners of the member 82.

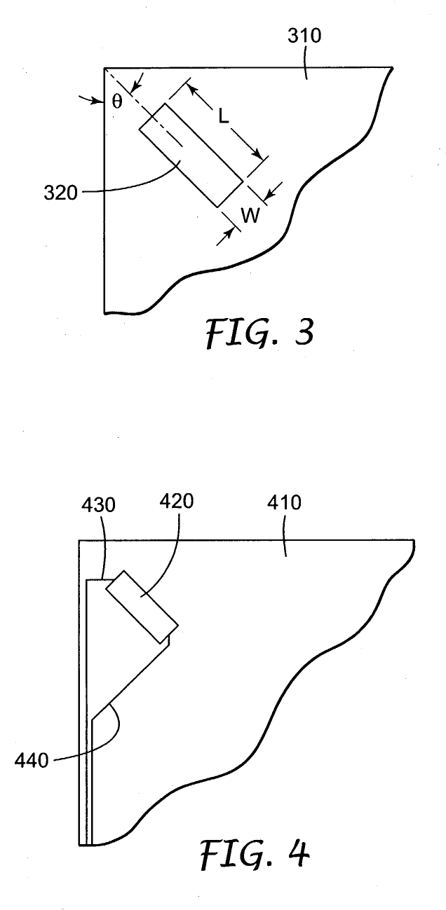

FIG. 3 shows a corner portion of a touch panel like that shown in FIG. 2, including a substrate 310 and a rectangular sensor 320. The sensor can be characterized by its length L, its width W, and its height, or thickness, (not indicated), as well as by its position relative to the corner of the substrate and by the angle θ that its axis of sensitivity makes with an edge of the substrate.

FIG. 4 shows a partial plan view of a touch panel that includes a substrate 410, a piezoelectric sensor 420 and wires 430 and 440 electrically connected to the sensor 420. When sensor 420 is stressed under the influence of a vibration propagates in the panel under the influence of a discrete touch, a charge gradient is created in the piezoelectric material, causing a voltage drop through the thickness of the material. By connecting wires to electrodes on the top and bottom of the piezoelectric sensor, this signal can be communicated to controller electronics (not shown) for computation and interpretation of the signal to determine touch position. Piezoelectric devices are available where the electrode on one side of the device is wrapped around to extend slightly onto the other side of the device so that the wires can be more conveniently connected due to both electrodes being accessible on the same side of the device. For example, in FIG. 4, wires 430 and 440 can be placed on substrate 410 so that properly placing, orienting, and affixing sensor 420 brings each of the wires into contact with a unique one of the electrodes.

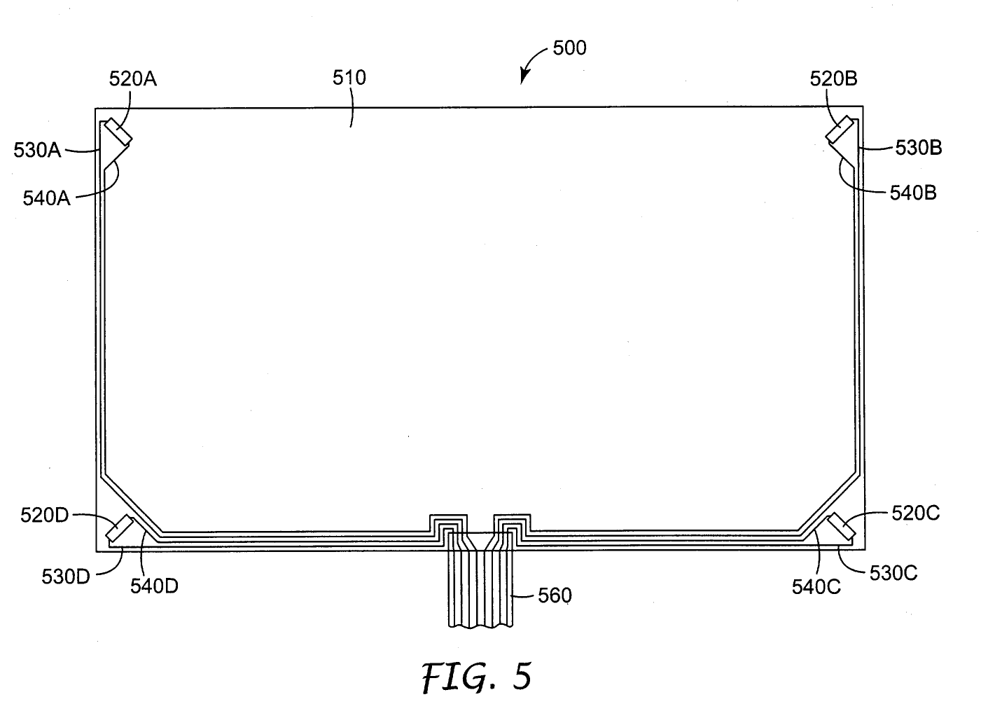

FIG. 5 shows a schematic plan view of a touch panel 500 that includes a substrate 510, sensor devices 520A, 520B, 520C and 520D, each of which is connected to a pair of wires, 530A and 540A, 530B and 540B, 530C and 540C, and 530D and 540D, respectively. The pairs of wires extend from their respective sensors along edges of the substrate to an area where tail 560 can be connected. Tail 560 can provide a convenient means of connecting the wires to controller electronics (not shown) that determine and report the location of a touch input using the information gathered from each of the sensors from sensing bending wave vibrations due to the touch.

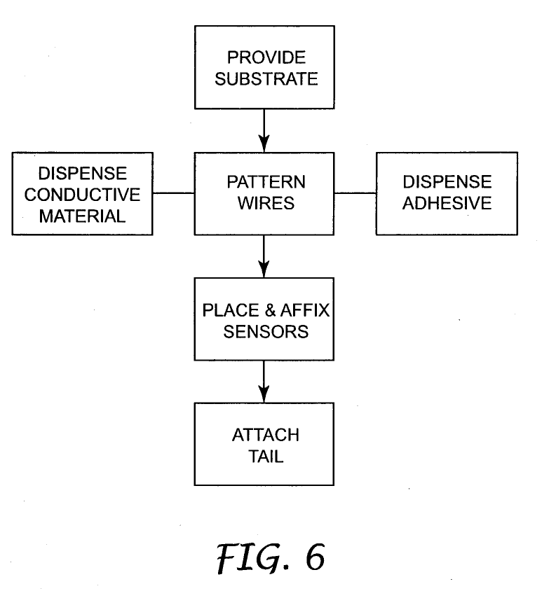

FIG. 6 indicates steps that may be performed in making a vibration sensing touch panel of the present invention. While the steps are indicated in a particular sequential order, it will be understood that the steps can be performed in any suitable order, and can be performed sequentially or simultaneously as desired and as is practicable. A substrate can be provided that supports vibration propagation and that will become the touch plate for the touch panel device. Preferably, the substrate is rectangular. The substrate can be formed, sized, and cut before performing the additional steps or can be cut to size after placing any or all of the wires, sensors, tail, and so forth. Optionally, the substrate can be coated to provide an anti-glare or anti-reflective finish, a textured surface, or other optical or otherwise functional elements.

Wires can be patterned on the substrate that lead from the areas where the sensors are to be placed to the area where a tail is to be connected to the touch panel. For piezoelectric devices, a pair of wires is patterned for each sensor, one of the wires in each pair of wires being placed to electrically connect with a unique one of the sensor electrodes. Before, after, or during patterning of the wires, an optional conductive material can be dispensed to aid in making an electrical connection between the wires and the electrodes of the sensors. For example, a solder, a conductive adhesive, a conductive grease, or another suitable conductive material can be dispensed on the substrate in the sensor areas where contact is to be made between the wires and the sensor electrodes. Alternatively or additionally, conductive material can be dispensed directly onto the sensors. In other embodiments, such conductive material may not be used. Prior to placing the sensors in the selected sensor areas, an adhesive material may also be dispensed onto the substrate, onto the sensors, or both, to aid in affixing or bonding of the sensors to the substrate so the sensors can be mechanically coupled to the substrate. The adhesive material can be any suitable adhesive material, and may require a further step of curing by heating, exposure to radiation, or other means.

The sensors are placed on the selected sensor areas of the substrate and affixed. Sensor placement can occur before or after patterning the wires. If the sensors are placed after patterning the wires, and conductive material is used to help electrically connect the sensors to the wires, the conductive material should be dispensed on the substrate, on the sensors, or both, before placing and affixing the sensors. If the sensors are placed before patterning the wires, and conductive material is used to help electrically connect the sensors to the wires, the conductive material should be dispensed on the sensors after placing and affixing the sensors, but may be applied before or after patterning the wires.

An electrical tail having leads to connect to each of the patterned wire traces can be attached to the touch panel. The tail can be attached before or after the wires are patterned, and a conductive material may be used to aid in electrically connecting the leads of the tail to the patterned wires. For example, the leads of the tail can be soldered to the wires. As another example, a conductive adhesive such as a z-axis conductive adhesive can be used to connect the tail leads to the patterned wires. A z-axis conductive adhesive can be placed over the entire tail connection area, and when the tail is placed, the z-axis conductive adhesive electrically connects each lead with its corresponding wire trace. A z-axis conductive adhesive provides for electrical connections through the thickness of the adhesive layer and substantially prevents electrical connections in the plane of the adhesive layer to inhibit crosstalk between adjacent wires.

Methods of making a bending wave touch input device according to the present invention can lend themselves to controlled, high volume, low cost manufacturing, which can include the automation of some or all of the fabrication steps. While hand wiring, soldering, and sensor placement can be used, such steps tend to be labor intensive, imprecise and costly. According to the present invention, touch panels of the present invention can be constructed by printing the wires (via screen printing, ink jet printing, or another suitable printing technique), liquid dispensing of conductive materials and/or adhesive materials, robotic placement of piezoelectric sensor components, and bonding of tail connectors using an anisotropic adhesive. Automated machines with excellent process control, high speed and low cost can perform all of these processes. Moreover, such a construction process can result in very repeatable, high quality attachment of the piezoelectric transducers, which can enhance the predictability and performance of the touch sensor.

In an exemplary embodiment, a vibration sensing touch panel includes a rectangular sheet of soda lime glass (although other materials that support desired vibrations such as bending waves can also be used), and four piezoelectric transducer sensors, each mounted near one of the four corners of the sheet. Preferred sensors are PZT crystals manufactured with conductive material wrapped around the edge of the crystal so that one side of the crystal has each of the two required contacts to connect to the electrical circuit. The utility of such a design is that the contacts are on the same side of the crystal, simplifying the construction of the touch panel by allowing both wires to be patterned directly on the substrate before placing the sensors.

In one embodiment, the first step in manufacturing the panel is to print conductive silver traces onto a provided substrate to form a circuit. The circuit may consists of eight traces, with two traces extending from each corner and following a path along the sides of the substrate to an edge area where a tail is to be bonded. An example of a circuit layout is shown in FIG. 5. In each corner, a conductive material can be dispensed (for example, by syringe-type dispensing, stencil printing, or other suitable means) onto the ends of the silver circuit in areas that correspond to where the end conductive pads on the PZT devices will be located when the devices are placed. Then an adhesive material can be dispensed to cover at least a substantial portion of the selected piezoelectric sensor area. The PZT crystals can be robotically placed into position, making contact with the conductive material and being physically bonded to the glass substrate through the adhesive material. The physical bond between the crystal and the substrate couples the crystal to the substrate so that vibrations of interest propagating in the substrate due to a touch event can be sensed. Vibrations in the glass substrate that are created by a touch or tap on the surface can thereby transfer stress into the crystal to create an electrical signal. Accurate dispensing of the proper amount of each of the materials, and accurate placement the piezoelectric crystals can provide consistency and repeatability of touch panel construction, and at high speed.

As discussed, each pair of traces that contact the piezoelectric devices continue along the outer edge of the glass substrate to a convenient location for the attachment of a flexible tail. This tail is used to connect to the electrical circuit that measures the signals and determines the touch position. A flex tail can be attached via an anisotropic adhesive as discussed. Alternately, it is possible to solder wires or a flat flex circuit to the traces. Preferably a frit-based solder is used. The end of the tail can terminate in a number of ways including but not limited to, zero insertion force (ZIF), crimped terminal (such as AMP) or direct soldered to a circuit board.

The following are exemplary materials for making touch input devices of the present invention.

The substrate can be soda lime glass, acrylic, polycarbonate, borosilicate glass, or the like. Soda lime glass is durable with respect to resistance to surface scratching from repeated use, and has a relatively low cost. Any of these substrates can be coated or textured (for example, by etching) for enhanced functionality, glare reduction, enhanced transmission, and enhanced contrast, and the like.

The conductive ink used to print the wires can be a silver filled epoxy polymer thick film ink (such as EP5600 available from Ercon, CT5030 available from Emerson & Cummings, or another commercially available epoxy silver ink), a printable silver frit, an ink jet printable conductive material, other polymer inks that can be printed to form conductive traces, as well as sputtered or plated metallic coatings that are patterned via masking, lift-off, or photolithographic methods. Screen printing of silver inks provides low cost and high speed, as well as reasonable processing temperatures (for example, less than 200 degrees C.), long pot life (approximately 72 hours), and excellent printing quality. Frits often require much higher temperatures for firing, and many other conductive inks either print poorly, have poor adhesion to glass, or have very short pot lives.

It may be desirable to use a conductive adhesive to bond the piezoelectric sensors such that the material provides both the mechanical bond to the substrate as well as the electrical connection to the wire traces. Alternately, an epoxy, urethane, or cyanoacrylate (isocyanate) adhesive can be used to make the mechanical bond, and a separate conductive silver-filled epoxy or other conductive material can be used to make the electrical connection. It is also possible to use silver frit for the wire traces and then solder the piezoelectric devices to the frit using a solder paste, although high temperature processing may be required.

Anisotropic, or z-axis, conductive adhesive is an exemplary vehicle for attaching a flexible conductive circuit tail to the glass for subsequent connection of the touch input device to a circuit board. Other options include using conductive glue or epoxy to bond wires, or soldering to frit, each of which may have various deficiencies due to hand labor requirements or thermal processing issues.

The advantages of the present invention will be appreciated from the above description. The invention should not be considered limited to the preferred embodiments. Alternative embodiments may be readily apparent to the skilled artisan upon review of the present specification. For example, other functionality may be incorporated into the touch panel. A variety of end use applications of the described touch sensor will also become apparent.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A touch input device comprising:
a rectangular substrate;
at least three elongated piezoelectric sensors coupled to the substrate and configured to sense vibrations propagating in the substrate that are indicative of a touch on the touch input device, each sensor located near a corner of the substrate and oriented to provide symmetric sensitivity to the direction of vibration propagation; and
controller electronics coupled to the sensors and configured to calculated touch location using information from the sensed vibrations indicative of the touch.

2. The touch input device of claim 1, wherein the substrate comprises glass.

3. The touch input device of claim 2, wherein the substrate comprises soda lime glass.

4. The touch input device of claim 1, wherein the substrate comprises a plastic.

5. The touch input device of claim 4, wherein the substrate comprises an acrylic.

6. The touch input device of claim 4, wherein the substrate comprises a polycarbonate.

7. The touch input device of claim 1, wherein the substrate comprises a textured touch surface.

8. The touch input device of claim 1, wherein the substrate comprises an anti-glare coating.

9. The touch input device of claim 1, wherein the substrate comprises an anti-reflective coating.

10. The touch input device of claim 1, wherein the substrate comprises a scratch resistant coating.

11. The touch input device of claim 1, wherein the rectangular substrate is square.

12. The touch input device of claim 1, wherein the sensors comprise lead-zirconate-titanate crystals.

13. The touch input device of claim 1, wherein the sensors are rectangular.

14. The touch input device of claim 13, wherein the sensors have about a 3:1 length to width aspect ratio.

15. The touch input device of claim 1, wherein the sensors have an axis of greatest sensitivity oriented to form about a 45 degree angle with adjacent edges of the substrate.

16. The touch input device of claim 1, wherein the sensors are coupled to a touch surface of the substrate.

17. The touch input device of claim 1, wherein the sensors are coupled to a surface of the substrate opposing a touch surface of the substrate.

18. The touch input device of claim 1, comprising four elongated piezoelectric sensors coupled to the substrate, each sensor positioned in a corner of the substrate.

19. The touch input device of claim 1, wherein at least one of the sensors is further configured to act as a vibration emitter.

20. The touch input device of claim 1, further comprising a printed pair of wires corresponding to each sensor and disposed on the substrate for coupling the sensors to the controller electronics.

21. The touch input device of claim 20, further comprising a flexible circuit tail connected to the pairs of wires on the substrate for coupling the sensors to the controller electronics.

22. A touch input device system comprising:
a rectangular substrate;
at least three elongated piezoelectric sensors coupled to the substrate and configured to sense vibrations propagating in the substrate that are indicative of a touch on the touch input device, each sensor located near a corner of the substrate and oriented to provide symmetric sensitivity to the direction of vibration propagation;
controller electronics coupled to the sensors and configured to calculated touch location using information from the sensed vibrations indicative of the touch; and
a display disposed for viewing through the touch input device.

23. The touch input device system of claim 22, wherein the display comprises a liquid crystal display.

24. The touch input device system of claim 22, wherein the display comprises a cathode ray tube.

25. The touch input device system of claim 22, wherein the display comprises an electroluminescent display.

26. The touch input device system of claim 22, wherein the display comprises a light emitting diode display.

27. The touch input device system of claim 22, wherein the display comprises a plasma display panel.

28. The touch input device system of claim 22, wherein the display comprises static graphics.

29. A touch input panel comprising:
a rectangular substrate;
at least three elongated piezoelectric sensors coupled to the substrate and configured to sense vibrations propagating in the substrate that are indicative of a touch on the touch input device, and coupled to wires configured for communicating information from the sensed vibrations to a controller for calculating touch location using said information, each sensor located near a corner of the substrate and oriented to provide symmetric sensitivity to the direction of vibration propagation.

30. A method for making a touch input device comprising:
providing a rectangular substrate capable of supporting vibrations propagating in the substrate that are indicative of a touch on the substrate;
selecting sensor areas on the substrate near the substrate corners and a tail area on the substrate near an edge of the substrate;
patterning pairs of wires on the substrate, each pair of wires extending along one or more edges of the substrate from one of the sensor areas to the tail area;
providing piezoelectric sensors activatable by applying voltage across two electrodes, the electrodes configured to be accessible from the same side of the sensor; and
affixing one of the sensors to each of the sensor areas so that each wire of each respective pair of wires electrically connects to a unique one of the electrodes of each respective sensor.

31. The method of claim 30, wherein the substrate is rectangular in shape.

32. The method of claim 31, wherein the substrate is square.

33. The method of claim 30, wherein the substrate comprises glass.

34. The method of claim 30, wherein the substrate comprises an acrylic.

35. The method of claim 30, wherein the step of patterning pairs of wires comprises printing a conductive material.

36. The method of claim 35, wherein printing comprises screen printing.

37. The method of claim 35, wherein printing comprises ink jet printing.

38. The method of claim 30, wherein the step of patterning pairs of wires comprises depositing a conductive material through a mask.

39. The method of claim 30, wherein the step of patterning pairs of wires comprises photolithographically patterning a conductive material.

40. The method of claim 30, wherein the step of patterning pairs of wires comprises using a conductive epoxy ink.

41. The method of claim 40, wherein the conductive epoxy ink comprises silver.

42. The method of claim 30, wherein the step of patterning pairs of wires comprises using a conductive frit-based material.

43. The method of claim 30, wherein the piezoelectric sensors comprise lead-zirconate-titanate crystals.

44. The method of claim 30, wherein the piezoelectric sensors are elongated.

45. The method of claim 44, wherein the piezoelectric sensors are rectangular.

46. The method of claim 45, wherein the piezoelectric sensors have about a 3:1 length to width aspect ratio.

47. The method of claim 44, wherein the piezoelectric sensors are affixed to provide symmetric sensitivity to the direction of vibration propagation in the substrate.

48. The method of claim 30, wherein the step of affixing the sensors comprises dispensing an adhesive between the substrate and the sensors.

49. The method of claim 48, wherein the adhesive is dispensed on the substrate.

50. The method of claim 48, wherein the adhesive is dispensed on the sensors.

51. The method of claim 48, wherein the dispensed adhesive comprises a conductive adhesive that electrically connects the pairs of wires to the sensors.

52. The method of claim 30, wherein the pairs of wires are electrically connected to the sensors via conductive material dispensed on the substrate.

53. The method of claim 30, wherein the pairs of wires are electrically connected to the sensors via conductive material dispensed on the sensors.

54. The method of claim 30, wherein the step of affixing the sensors comprises robotically placing the sensors on the substrate.

55. The method of claim 30, further comprising bonding a flexible circuit tail to the substrate so that the tail electrically connects with each of the wires of the pairs of wires for coupling to controller electronics.

56. The method of claim 55, wherein the tail is bonded by soldering.

57. The method of claim 55, wherein the tail is bonded using a z-axis conductive adhesive.

58. The method of claim 30, wherein the wires are patterned on the substrate prior to affixing the sensors.

59. The method of claim 30, wherein the sensors are affixed on the substrate prior to patterning the wires.
